(19) United States
(12) Patent Application Publication
(10) Pub. No.: US 2018/0030966 A1
(43) Pub. Date: Feb. 1, 2018

(54) DEVICE OF GREASE GUN

(71) Applicant: JELLEY TECHNOLOGY CO., LTD., Hsinchu City (TW)

(72) Inventors: Feng-Ho WANG, Hsinchu City (TW); De-Shian HUANG, Hsinchu City (TW)

(21) Appl. No.: 15/221,802

(22) Filed: Jul. 28, 2016

(51) Int. Cl. F04B 9/04; F04B 1/02; F04B 15/02; F04B 53/10; F04B 23/02; F04B 53/14; F04B 53/16; F16N 3/12; F04B 19/22

(52) U.S. Cl. CPC F04B 9/042; F16N 3/12; F04B 1/02; F04B 15/02; F04B 19/22; F04B 23/028; F04B 53/14; F04B 53/16; F04B 53/1002; F04B 53/1087

(57) ABSTRACT

A device of a grease gun is used for delivering a viscous liquid to flow from a reservoir of the viscous liquid to a hose. The device includes a delivery head, two plungers, a cam member, and a drive source configured to drive the cam member to rotate. The delivery head has an outlet port for delivering the viscous liquid into the hose, two bores, and an intake port disposed for receiving the viscous liquid from the reservoir. Each of the plungers is slidably disposed in a corresponding one of the bores. Rotation of the cam member is translated into linear reciprocating motions of the plungers so as to permit the viscous liquid to alternately flow into the bores and then to flow out of the outlet port.

### FIELD

The disclosure relates to a device of a grease gun, more particularly to a device of a grease gun for delivering a viscous liquid to flow from a reservoir of the viscous liquid to a hose.

### BACKGROUND

In a conventional grease gun, a reciprocating movement of a plunger is used for delivering lubricant from a reservoir to a hose, and is normally driven by a relatively complicated structure including multiple stages of planetary gears, a sliding member, etc. Therefore, the conventional grease gun is relatively bulky and heavy. In addition, because the conventional grease gun only has a single plunger, the lubricant does not flow out continuously.

For delivering lubricant continuously, Taiwanese patent no. I302973 discloses a conventional grease gun which includes a device 1 for delivering lubricant to flow from a reservoir 21 of the lubricant to a hose 24, as shown in FIG. 1. The device 1 includes a head 10 (including a head body 11 and a head extension 111), two plungers 125, a transmission unit 12, and a drive unit 13.

The head body 11 has two bores 110 and an outlet port 100, and is mounted to the reservoir 21. The head body 11 is configured to permit the lubricant to flow into the two bores 110 and then to the hose 24 through the outlet port 100. The head extension 111 extends rearwardly from the head body 11, and has a lower wall 112 and two sidewalls 113 which define thereamong a space 103. The two plungers 125 are slidably disposed in the two bores 110, respectively. Each of the two plungers 125 is displaceable between a rearward position and a forward position. When in the rearward position, the lubricant is free to flow into a corresponding one of the two bores 110. When in the forward position, the lubricant in the corresponding one of the two bores 110 is pushed forward to flow out of the outlet port 111.

The transmission unit 12 is disposed in the space 103 and includes a shaft 121, a main gear 122, two limiting members 123, and two cam members 124 (only one is shown). The shaft 121 has two ends which are rotatably mounted to the sidewalls 113, respectively. The main gear 122 is mounted for rotation on the shaft 121. The two cam members 124 are mounted respectively on two opposite sides of the main gear 122 to rotate with the main gear 122, and are disposed radially offset from the shaft 121, respectively. In addition, the two cam members 124 are disposed opposite to each other relative to the shaft 121. Each of the limiting members 123 has a stem segment 101 secured to a corresponding one of the two plungers 125, and an annular segment 102 disposed to surround and engage a corresponding one of the two cam members 124. When the main gear 122 is driven to rotate, a camming action between the annular segment 102 of a corresponding of the limiting members 123 and the corresponding one of the two cam members 124 causes a reciprocating motion of the corresponding one of the two plungers 125.

The drive unit 13 has a motor 131 and a pinion gear 132 which is coupled to be driven by the motor 131 to rotate, and which is disposed to mesh with the main gear 122 so as to drive the main gear 122 to rotate. When the pinion gear 132 is driven to rotate, the main gear 122 is rotated such that the lubricant is alternately introduced into the two bores 110 and is alternately pushed by the two plungers 125 so as to permit the lubricant to continuously flow out of the outlet port 100.

However, the conventional grease gun as shown in FIG. 1 has the reservoir 21, the head 10, and the drive unit 12 extending in three different directions, and thus is not convenient for storage.

### SUMMARY

Therefore, an object of the disclosure is to provide a novel device of a grease gun for delivering a viscous liquid to flow from a reservoir of the viscous liquid to a hose. With the novel device, the grease gun is light-weight and convenient for storage, and can be easily assembled. In addition, the viscous liquid can be delivered continuously by the grease gun.

According to the disclosure, a device for delivering a viscous liquid to flow from a reservoir of the viscous liquid to a hose is disclosed. The device includes a delivery head, two plungers, a cam member, and a drive source. The delivery head has an outlet port disposed for delivering the viscous liquid into the hose, two spaced apart bores, and an intake port. Each of the two bores is disposed to be in fluid communication with the outlet port. The intake port is disposed upstream of the two bores for receiving the viscous liquid from the reservoir. Each of the two plungers is slidably disposed in a corresponding one of the two bores to extend outwardly of the delivery head. The cam member has a cam path. The drive source is configured to drive the cam member to rotate about an axis. The axis extends in a longitudinal direction. Each of the two plungers is disposed to engage the cam path of the cam member such that rotation of the cam member is translated into linear reciprocating motions of the two plungers along the longitudinal direction to permit the viscous liquid to alternately flow into the two bores and then to flow out of the outlet port.

According to the disclosure, a device for delivering a viscous liquid to flow from a reservoir of the viscous liquid to a hose is disclosed. The device includes a delivery head, two check balls, a rear shell body, a drive source, two plungers, a cam member, and two biasing members. The delivery head extends in a longitudinal direction to terminate at a forward end and a rearward end. The delivery head has an intake port, two bores, two internal ports, an outlet port, and two valve seats. The intake port is disposed for receiving the viscous liquid from the reservoir. Each of the two bores extends in the longitudinal direction to terminate at a front valve hole and a rear through hole at the rearward end. Each of the two bores has a front zone adjacent to the front valve hole. Each of the two internal ports is disposed downstream of the intake port and upstream of the front zone of a corresponding one of the two bores. The outlet port is disposed downstream of the front valve holes of the two bores for delivering the viscous liquid into the hose. Each of the two valve seats defines the front valve hole of the corresponding one of the two bores. Each of the two check balls is disposed to couple with a corresponding one of the valve seats to permit a unidirectional flow of the viscous liquid from the front zone of the corresponding one of the two bores to the outlet port through the front valve hole of the corresponding one of the valve seats. The rear shell body is disposed rearwardly of the delivery head, and defines therein a chamber which extends forwardly to terminate at an open end in spatial communication with the rear through holes of the two bores. The drive source is disposed in the chamber, and has an output shaft configured to be driven to rotate about a shaft axis in the longitudinal direction. Each of the two plungers extends in the longitudinal direction to terminate at a plunger end segment and a follower end. The follower end is located in the chamber. The plunger end segment is slidably disposed in the corresponding one of the two bores, and is displaceable between a forward position, where a corresponding one of the two internal ports is prevented from fluid communication with the front zone of the corresponding one of the two bores, and a rearward position, where the corresponding one of the two internal ports is in fluid communication with the front zone of the corresponding one of the two bores to permit the viscous liquid to be introduced into the front zone of the corresponding one of the two bores through the corresponding one of the two internal ports. The cam member is disposed in the chamber, and is configured to be splinedly engaged with the output shaft so as to permit the cam member to rotate with the output shaft. The cam member has a front end which defines a cam path extending in a circumferential direction about the shaft axis. The cam path is configured to permit the follower ends of the two plungers to engage the cam path to provide a camming action such that when the cam member is driven by the output shaft to rotate, by virtue of the camming action, the plunger end segments of the two plungers are alternately displaced from the rearward position to the forward position so as to alternately force the introduced viscous liquid to flow through the front valve hole of the corresponding one of the valve seats to thereby establish a continuous flow of the viscous liquid out of the outlet port. Each of the two biasing members is disposed to bias the plunger end segments of a corresponding one of the two plungers toward the rearward position.

### BRIEF DESCRIPTION OF THE DRAWINGS

Other features and advantages of the disclosure will become apparent in the following detailed description of the embodiment with reference to the accompanying drawings, in which:

FIG. 1 is a perspective view of a conventional grease gun;

FIG. 2 is a perspective view of a grease gun according to an embodiment of the disclosure;

FIG. 3 is a perspective view of a portion of a delivering device mounted in the grease gun shown in FIG. 2;

FIG. 4 is an exploded perspective view of the delivering device shown in FIG. 3;

FIG. 5 is a cross-sectional view taken along line V-V of FIG. 3;

FIG. 6 is a schematic view illustrating a cam path of a cam member in the delivering device;

FIG. 7 is a plot illustrating strokes of two plungers in the delivering device;

FIG. 8 is a cross-sectional view taken along line VIII-VIII of FIG. 5, illustrating one of two plungers is in a forward position; and

FIGS. 9 and 10 are similar to FIG. 8 but illustrating the two plungers in different positions.

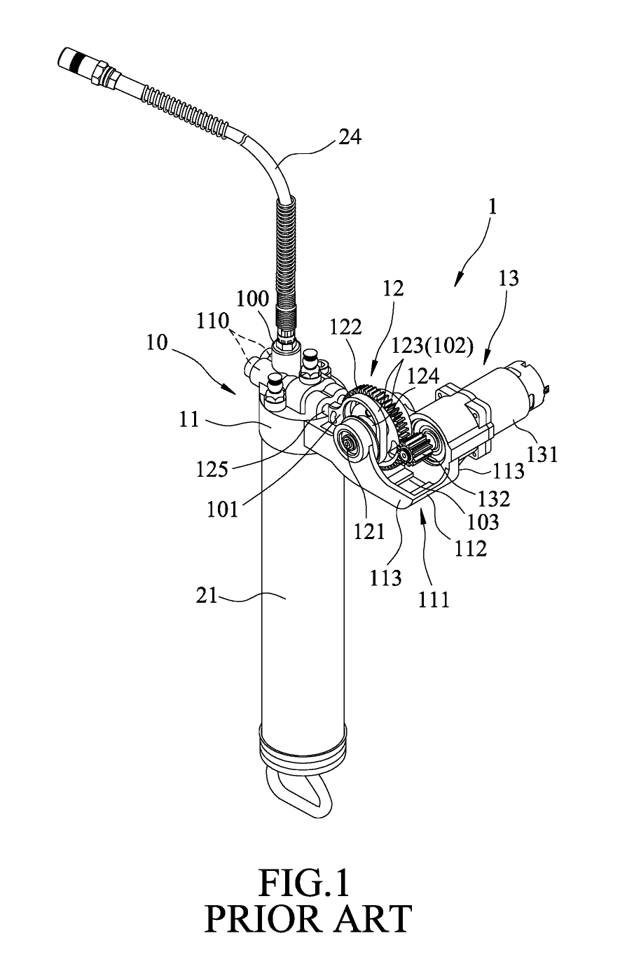

### DETAILED DESCRIPTION

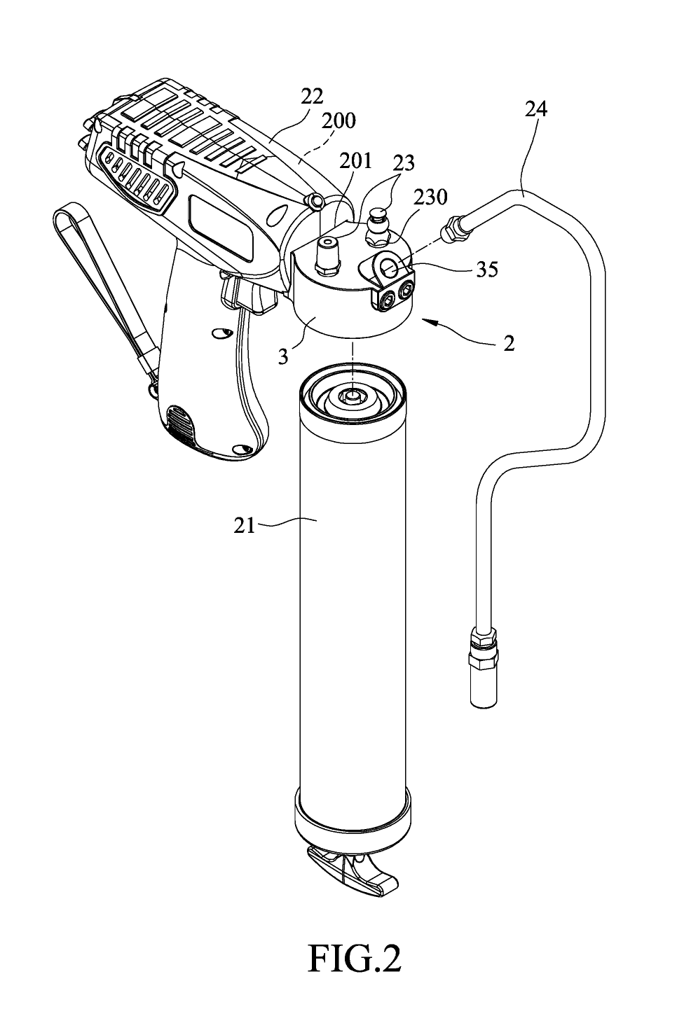

With reference to FIG. 2, a grease gun according to an embodiment of the disclosure includes a delivery device 2 for delivering a viscous liquid to flow from a reservoir 21 of the viscous liquid to a hose 24. In this embodiment, the viscous liquid is lubricant.

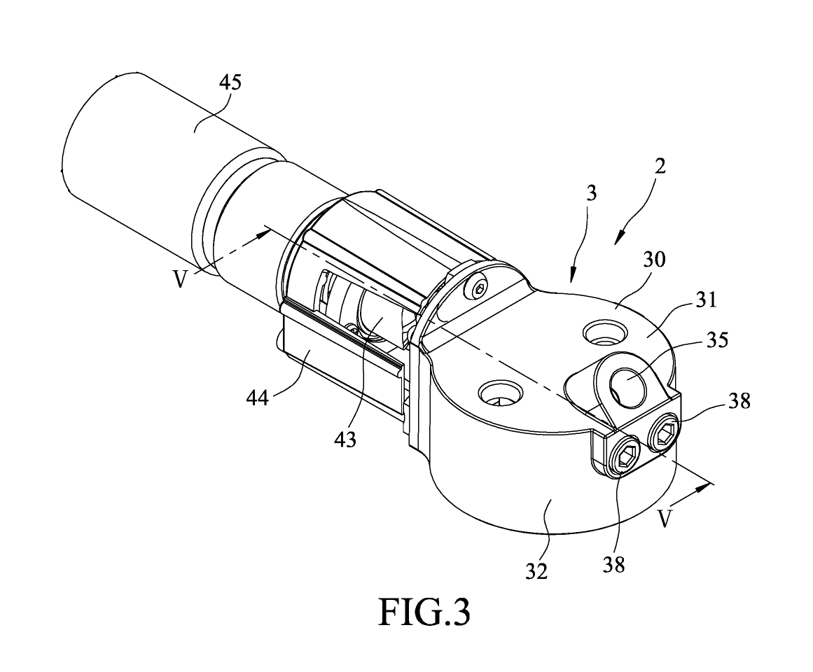

As shown in FIGS. 2 to 4, the device 2 includes a delivery head 3, two check valves 38, a rear shell body 22, a drive source 45, two plungers 41, a cam member 43, and two biasing members 42.

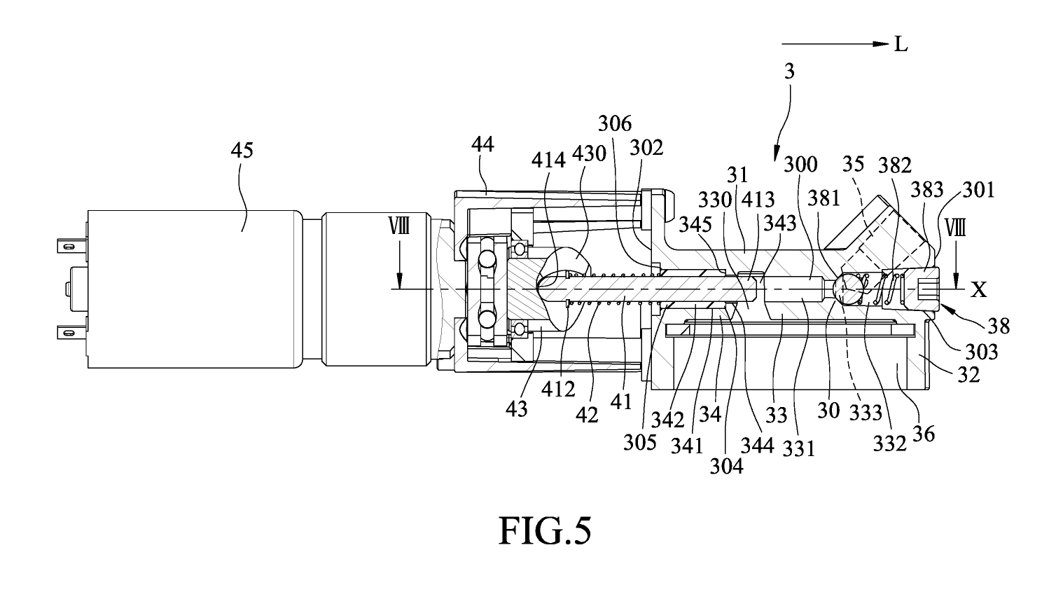

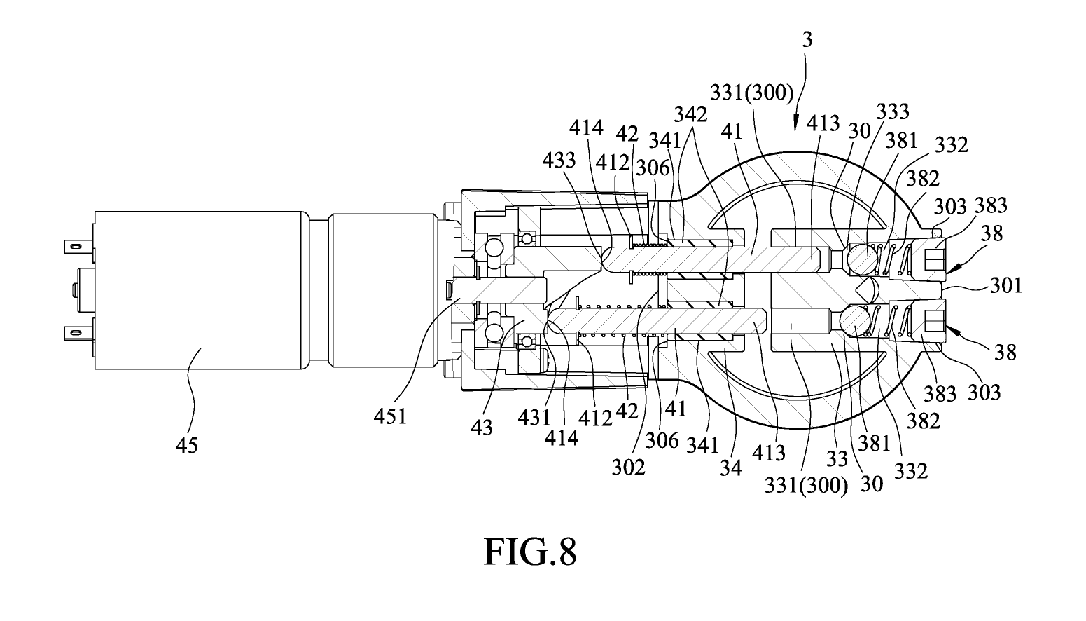

As shown in FIGS. 5 and 8, the delivery head 3 extends in a longitudinal direction (L) to terminate at a forward end 301 and a rearward end 302. The delivery head 3 has an intake port 36, two spaced apart bores 300, two internal ports 330, an outlet port 35, and two valve seats 30.

The intake port 36 is disposed for receiving the viscous liquid from the reservoir 21.

Each of the two bores 300 extends in the longitudinal direction (L) to terminate at a front valve hole 333 and a rear through hole 306 at the rearward end 302. Each of the two bores 300 has a front zone 331 which is disposed adjacent to the front valve hole 333 and in fluid communication with the outlet port 35.

Each of the two internal ports 330 is disposed downstream of the intake port 36 and upstream of the front zone 331 of a corresponding one of the two bores 300.

The outlet port 35 is disposed downstream of the front valve holes 333 of the two bores 300 for delivering the viscous liquid into the hose 24.

Each of the two valve seats 30 defines the front valve hole 333 of the corresponding one of the two bores 300.

In this embodiment, the delivery head 3 has a main wall 31 and a surrounding wall 32. The main wall 31 includes a front segment 33 and a rear segment 34, and has the two bores 300, the two internal ports 330, the outlet port 35, and the two valve seats 30. The front zone 331 of each of the two bores 300 is formed in the front segment 33. The surrounding wall 32 extends downwardly from a periphery of the main wall 31 to define the intake port 36, and is configured to be mounted to the reservoir 21.

In this embodiment, as shown in FIG. 2, the reservoir 21 is of a cylindrical shape and has a replaceable cartridge with a spring-driven diaphragm (not shown) for urging the viscous liquid upward in the reservoir 21 toward the intake port 36 of the delivery head 3.

Referring back to FIG. 5, it can be observed that each of the two bores 300 further has an accommodation zone 343, a fitting zone 341, and a neck zone 344. The accommodation zone 343 has a first larger dimension, and is in radial alignment with a corresponding one of the two internal ports 330 to ease entry of the viscous liquid. The accommodation zone 343 is disposed to fluidly communicate the corresponding one of the two internal ports 330 with the front zone 331. The fitting zone 341 has a second larger dimension, and is disposed adjacent to the rearward end 302 of the delivery head 3. The neck zone 344 of a smaller dimension is disposed between the accommodation zone 343 and the fitting zone 341, and defines, together with the fitting zone 341, an abutment shoulder 345. The fitting zone 341 and the neck zone 344 are formed in the rear segment 34, and the accommodation zone 343 is formed between the front and rear segments 33, 34.

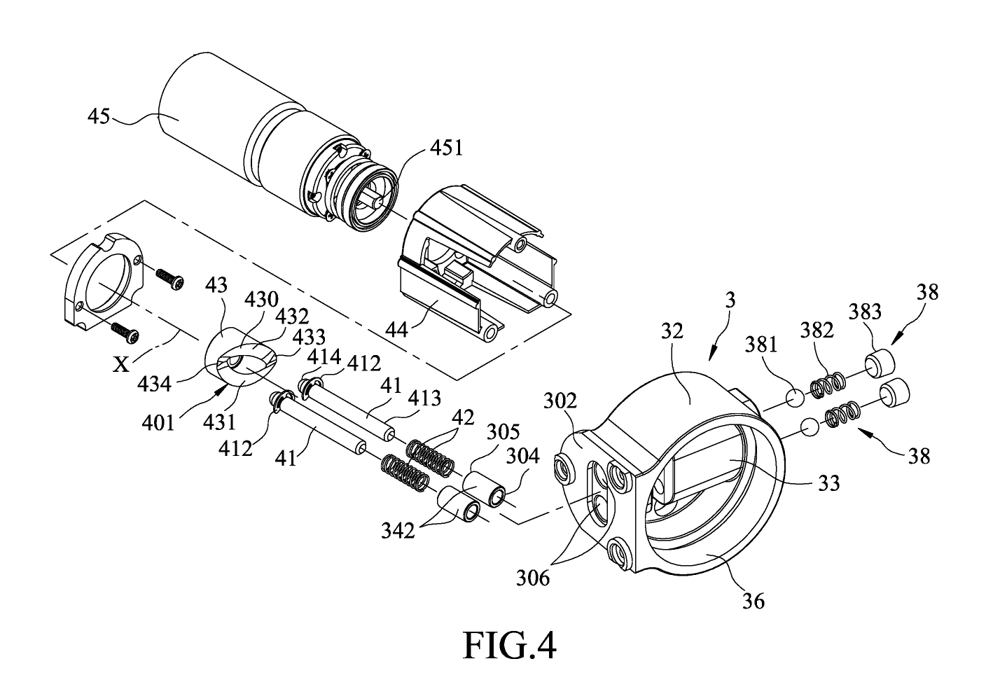

As shown in FIGS. 4, 5, and 8, the delivery head 3 further has two front through holes 303 at the forward end 301, and two valve ducts 332 each extending from a corresponding one of the front through holes 303 in the longitudinal direction (L) to be in spatial communication with the front valve hole 333 of a corresponding one of the valve seats 30. As shown in FIG. 5, the valve ducts 332 are formed in the front segment 33.

Each of the check valves 38 is disposed in a corresponding one of the two valve ducts 332, and includes a check ball 381 disposed to couple with the corresponding one of the valve seats 30 to permit a unidirectional flow of the viscous liquid from the front zone 331 of the corresponding one of the two bores 300 to the outlet port 35 through the front valve hole 333 of the corresponding one of the valve seats 30.

In this embodiment, each of the check valves 38 further includes an end cap 383 and a biasing spring 382. The end cap 383 is disposed to be fitted into the corresponding one of the front through holes 301 and in liquid-tight engagement with the forward end 301. The biasing spring 382 is disposed between the check ball 381 and the end cap 383 to bias the check ball 381 to couple with the corresponding one of the valve seats 30.

Referring back to FIG. 2, it can be seen that the rear shell body 22 is disposed rearwardly of the delivery head 3 and defines therein a chamber 200. The chamber 200 extends forwardly to terminate at an open end 201 in spatial communication with the rear through holes 306 of the two bores 300 (see FIGS. 5 and 8).

As shown in FIGS. 2, 4, 5, and 8, the drive source 45 is disposed rearwardly of the delivery head 3 and in the chamber 200, and has an output shaft 451 configured to be driven to rotate about a shaft axis (X) in the longitudinal direction (L). In this embodiment, the drive source 45 is configured to drive the cam member 43 to rotate about the shaft axis (X).

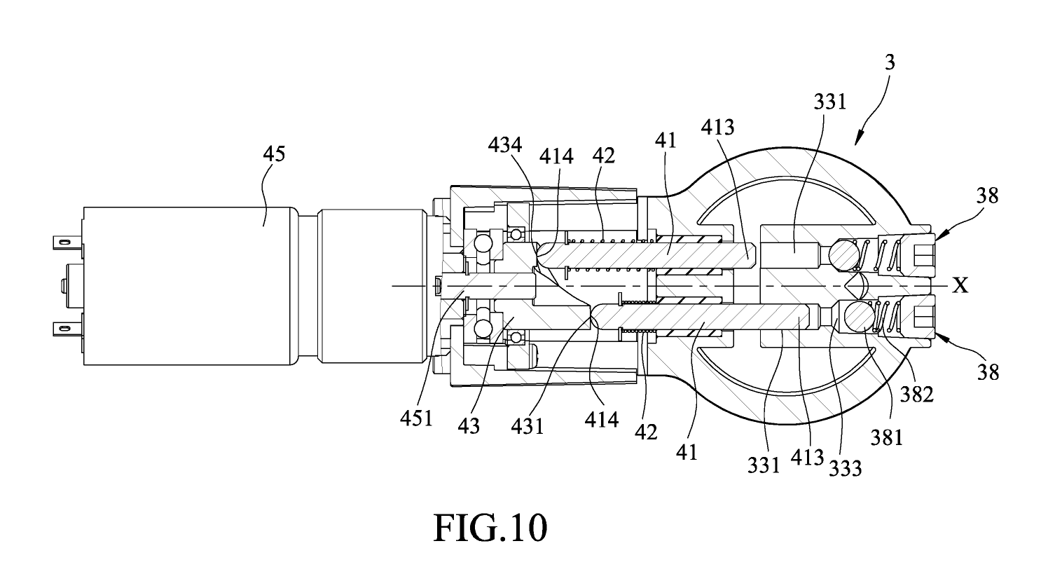

Each of the two plungers 41 extends in the longitudinal direction (L) to terminate at a plunger end segment 413 and a follower end 414. The follower end 414 is located in the chamber 200, and is disposed rearwardly of the delivery head 3. The plunger end segment 413 is disposed in the corresponding one of the two bores 300, and is displaceable between a forward position (see the upper one of the two plungers 41 in FIG. 8) and a rearward position (see the upper one of the two plungers 41 in FIG. 10). In the forward position, the corresponding one of the two internal ports 330 is prevented from fluid communication with the front zone 331 of the corresponding one of the two bores 300. In the rearward position, the corresponding one of the two internal ports 330 is in fluid communication with the front zone 331 of the corresponding one of the two bores 300 to permit the viscous liquid to be introduced into the front zone 331 of the corresponding one of the two bores 300 through the corresponding one of the two internal ports 330.

In this embodiment, as shown in FIG. 8, the two plungers 41 are substantially coplanar with the output shaft 451.

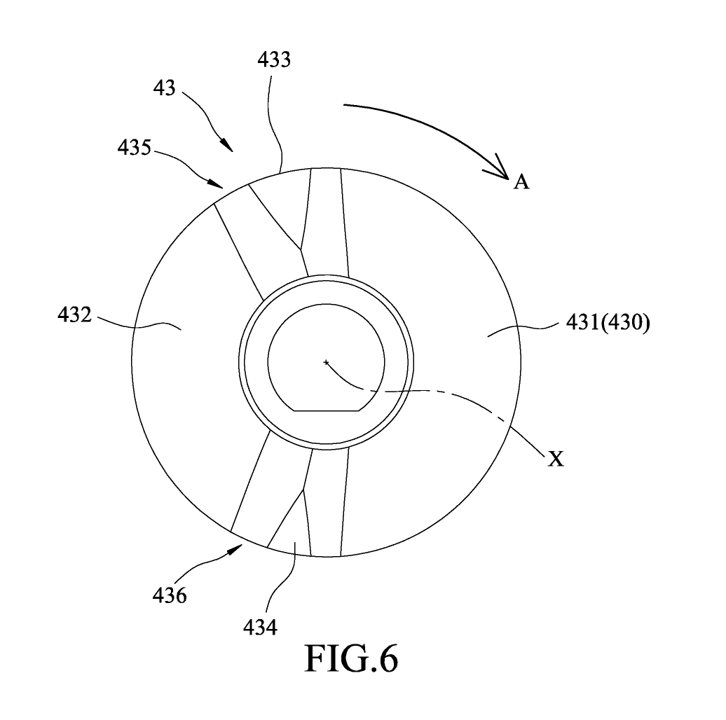

The cam member 43 is disposed in the chamber 200, and is configured to be splinedly engaged with the output shaft 451 so as to permit the cam member 43 to rotate with the output shaft 451. As shown in FIG. 4, the cam member 43 has a front end 401 defining a cam path 430 which extends in a circumferential direction about the shaft axis (X), and which is configured to permit the follower ends 414 of the two plungers 41 to engage the cam path 430 to provide a camming action (see FIGS. 5 and 8) such that when the cam member 43 is driven by the output shaft 451 to rotate, by virtue of the camming action, the plunger end segments 413 of the two plungers 41 are alternately displaced from the rearward position to the forward position so as to alternately force the introduced viscous liquid to flow through the front valve hole 333 of the corresponding one of the valve seats 30 to thereby establish a continuous flow of the viscous liquid out of the outlet port 35. When the plunger end segment 413 of each of the two plungers 41 is displaced from the rearward position to the forward position, the check ball 381 of a corresponding one of the check valves 38 is forced by the viscous liquid to disengage from the corresponding one of the valve seats 30 so as to permit the viscous liquid to be pushed to the outlet port 35. When the plunger end segment 413 of each of the two plungers 41 is displaced from the forward position to the rearward position, the check ball 381 of the corresponding one of the check valves 38 is urged by the biasing spring 382 to couple with the corresponding one of the valve seats 30. In this embodiment, the cam member 43 is rotated in a clockwise direction as shown by an arrow (A) in FIG. 6.

As shown in FIGS. 4 and 6, the cam path 430 has a foremost area 433 and a rearmost area 434.

The foremost area 433 is configured to permit the plunger end segment 413 of each of the two plungers 41 to reach the forward position (see the upper one of the two plungers 41 in FIG. 8).

The rearmost area 434 is configured to permit the plunger end segment 413 of each of the two plungers 41 to reach the rearward position (see the upper one of the two plungers 41 in FIG. 10). The foremost and rearmost areas 433, 434 are disposed opposite to each other relative to the shaft axis (X) so as to permit the plunger end segments 413 of the two plungers 41 to be alternately displaced from the rearward position to the forward position.

In this embodiment, the cam path 430 further has a front transition zone 435, a rear transition zone 436, a ramp-up zone 431, and a ramp-down zone 432.

The front transition zone 435 has the foremost area 433. The rear transition zone 436 has the rearmost area 434. The ramp-up zone 431 extends from the rear transition zone 436 in a counterclockwise direction to the front transition zone 435. The ramp-down zone 432 extends from the front transition zone 435 in the counterclockwise direction to the rear transition zone 436.

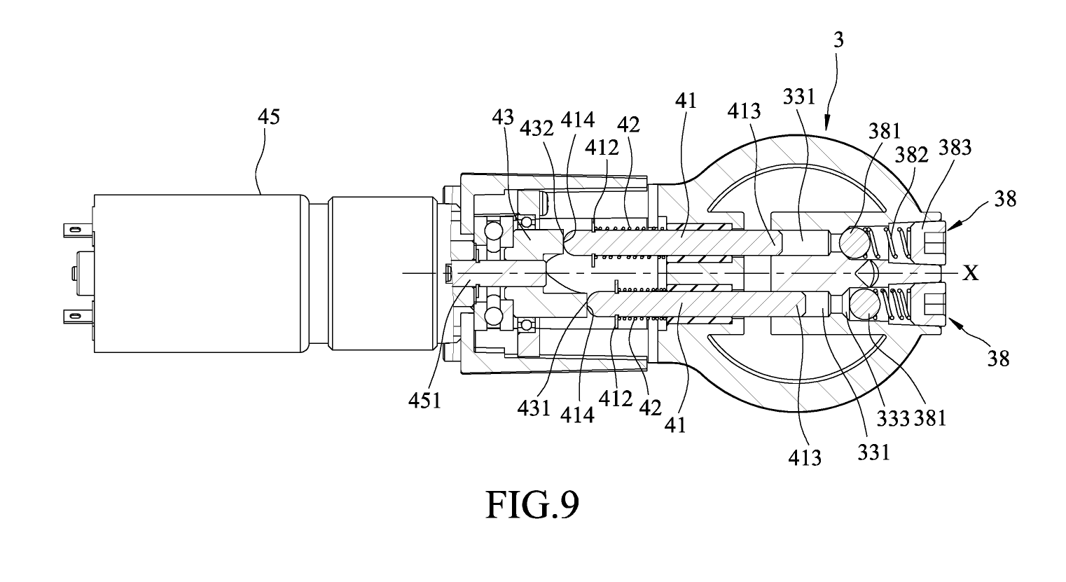

The ramp-up and ramp-down zones 431, 432 are configured such that when the cam member 43 is driven to rotate, one of the two plungers 41 (see the lower one of the two plungers 41 shown in FIG. 9) engages the ramp-up zone 431 and is displaced toward the forward position to force the viscous liquid to flow out of the outlet port 35, and the other one of the two plungers 41 (see the upper one of the two plungers 41 shown in FIG. 9) engages the ramp-down zone 432 and is displaced toward the rearward position so as to permit the viscous liquid to flow into the front zone 331 of the corresponding one of the two bores 300.

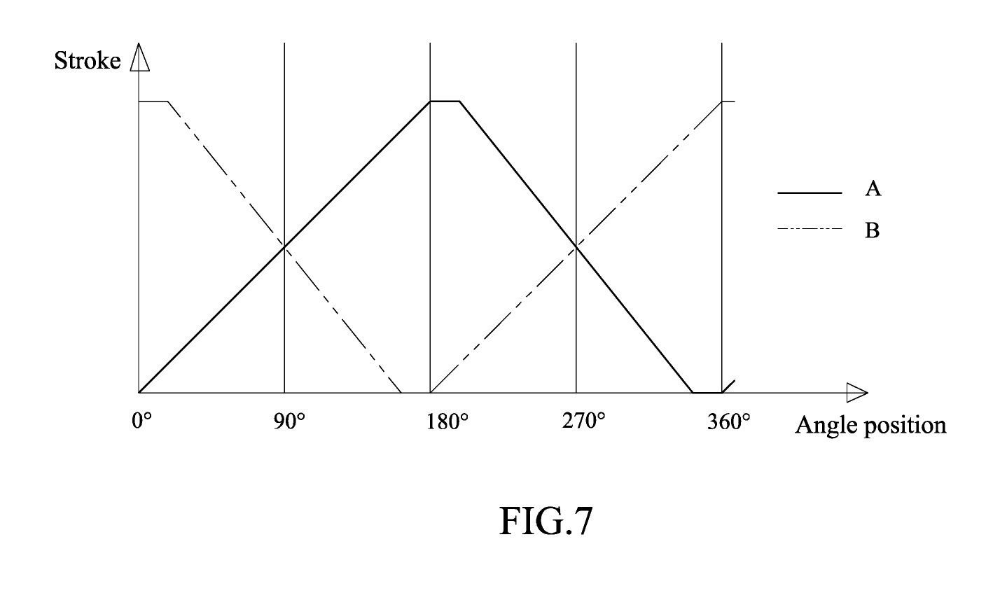

FIG. 7 illustrates a relation between a stroke of each plunger 41 and an angle position of each plunger 41. The stroke of one of the two plungers 41 is shown by Line A, and the stroke of the other one of the two plungers 41 is shown by Line B. The longitudinal coordinate represents a distance of the follower end 414 of the corresponding one of the plungers 41 away from the rearmost area 434. The transversal coordinate represents an angle position of the follower end 414 of the corresponding one of the plungers 41 relative to an initial position (0°), with respect to the shaft axis (X). Each of the follower ends 414 of the two plungers 41 goes through the cam path 430 for one circle (360°). The highest region of each of Lines A and B represents that the plunger end segment 413 of a corresponding one of the two plungers 41 reaches the foremost position. The lowest region of each of Lines A and B represents that the plunger end segment 413 of the corresponding one of the two plungers 41 reaches the rearmost position. It should be noted that a displacement time of one of the follower ends 414 of the two plungers 41 along the ramp-up zone 431 is substantially equivalent to a displacement time of the other one of the follower ends 414 of the two plungers 41 from the foremost area 433 along the ramp-down zone 432 to the rearmost area 434. In this embodiment, the ramp-up zone 431 has a curvature configured to permit the viscous liquid to be supplied to the hose 24 at a constant flow rate.

As shown in FIG. 5, each of the biasing members 42 is disposed to bias the plunger end segment 413 of the corresponding one of the two plungers 41 toward the rearward position.

In this embodiment, the device 2 further includes two bushings 343 and two flange members 412.

Each of the two bushings 343 has a front end 304 and a rear end 305, and is fitted in the fitting zone 341 of the corresponding one of the two bores 300 such that the front end 304 abuts against the abutment shoulder 345 of the corresponding one of the two bores 300. Because a liquid-tight seal is formed between each of the two bushings 343 and the corresponding one of the two plungers 41, the viscous liquid can be prevented from leaking out of the delivery head 3 through the fitting zones 341 of the two bores 300.

Each of the two flange members 412 is mounted on the corresponding one of the plungers 41 adjacent to the follower end 414. Each of the two biasing members 42 is sleeved on the corresponding one of the two plungers 41 and is disposed between the rear end 305 of a corresponding one of the two bushings 342 and a corresponding one of the two flange members 412.

In this embodiment, as shown in FIG. 2, the device 2 further includes two pressure relief valves 23 received respectively in two cavities 230 of the delivery head 3. The two cavities 230 are in spatial communication with the two bores 300, respectively. Each of the pressure relief valves 23 is configured to open when pressure of the viscous liquid in the corresponding one of the two bores 300 exceeds a predetermined level.

In this embodiment, as shown in FIG. 5, the device 2 further includes a shield member 44 disposed to connect the drive source 45 with the rearward end 302 of the delivery head 3. The cam member 43 and the follower ends 414 of the two plungers 41 are disposed inside the shield member 44.

In this embodiment, the grease gun further includes a power supply unit (not shown) which is disposed in the rear shell body 22 for supplying electricity to the drive source 45.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A device for delivering a viscous liquid to flow from a reservoir of the viscous liquid to a hose, said device comprising:
a delivery head having
an outlet port disposed for delivering the viscous liquid into the hose,
two spaced apart bores each being disposed to be in fluid communication with said outlet port, and
an intake port disposed upstream of said two bores for receiving the viscous liquid from the reservoir;
two plungers each being slidably disposed in a corresponding one of said two bores to extend outwardly of said delivery head;
a cam member having a cam path; and
a drive source configured to drive said cam member to rotate about an axis, said axis extending in a longitudinal direction, wherein
each of said two plungers is disposed to engage said cam path of said cam member such that rotation of said cam member is translated into linear reciprocating motions of said two plungers along the longitudinal direction to permit the viscous liquid to alternately flow into said two bores and then to flow out of said outlet port.

2. The device according to claim 1, wherein:
said delivery head extends in the longitudinal direction to terminate at a forward end and a rearward end, said delivery head further having two internal ports each of which is disposed downstream of said intake port and upstream of the corresponding one of said two bores, each of said two bores extending in the longitudinal direction and having a front zone;
each of said two plungers extends in the longitudinal direction to terminate at a plunger end segment and a follower end, said follower end being disposed rearwardly of said delivery head, said plunger end segment being slidably disposed in the corresponding one of said two bores, and being displaceable between a forward position, where a corresponding one of said two internal ports is prevented from fluid communication with said front zone of the corresponding one of said two bores, and a rearward position, where the corresponding one of said two internal ports is in fluid communication with said front zone of the corresponding one of said two bores to permit the viscous liquid to be introduced into said front zone of the corresponding one of said two bores through the corresponding one of said two internal ports;
said drive source is disposed rearwardly of said delivery head, and has an output shaft configured to be driven to rotate about the axis in the longitudinal direction; and
said cam member is configured to be splinedly engaged with said output shaft so as to permit said cam member to rotate with said output shaft, said cam path being configured to permit said follower ends of said two plungers to engage said cam path to provide a camming action such that when said cam member is driven by said output shaft to rotate, by virtue of the camming action, said plunger end segments of said two plungers are alternately displaced from the rearward position to the forward position.

3. The device according to claim 2, wherein said cam path has
a foremost area configured to permit said plunger end segment of each of said two plungers to reach the forward position, and
a rearmost area configured to permit said plunger end segment of each of said two plungers to reach the rearward position, said foremost and rearmost areas being disposed opposite to each other relative to the axis so as to permit said plunger end segments of said two plungers to be alternately displaced from the rearward position to the forward position.

4. The device according to claim 3, wherein said cam path further has
a front transition zone having said foremost area,
a rear transition zone having said rearmost area,
a ramp-up zone extending from said rear transition zone in a counterclockwise direction to said front transition zone, and
a ramp-down zone extending from said front transition zone in the counterclockwise direction to said rear transition zone, said ramp-up and ramp-down zones being configured such that when said cam member is driven to rotate, one of said two plungers engages said ramp-up zone and is displaced toward the forward position to force the viscous liquid to flow out of said outlet port, and the other one of said two plungers engages said ramp-down zone and is displaced toward the rearward position so as to permit the viscous liquid to flow into said front zone of the corresponding one of said two bores.

5. The device according to claim 4, wherein a displacement time of one of said follower ends of said two plungers along said ramp-up zone is substantially equivalent to a displacement time of the other one of said follower ends of said two plungers from said foremost area along said ramp-down zone to said rearmost area.

6. The device according to claim 4, wherein said delivery head further has two valve seats each defining a front valve hole which is disposed to fluidly communicate said front zone of the corresponding one of said two bores with said outlet port, said device further comprising two check valves each being disposed to couple with a corresponding one of said valve seats to permit a unidirectional flow of the viscous liquid from said front zone of the corresponding one of said two bores to said outlet port through said front valve hole of the corresponding one of said valve seats.

7. The device according to claim 6, wherein said delivery head further has two front through holes at said forward end, and two valve ducts each extending from a corresponding one of said front through holes in the longitudinal direction to be in spatial communication with said front valve hole of the corresponding one of said valve seats, each of said check valves including
a check ball,
an end cap disposed to be fitted into the corresponding one of said front through holes and in liquid-tight engagement with said forward end, and
a biasing spring disposed between said check ball and said end cap to bias said check ball to couple with the corresponding one of said valve seats.

8. The device according to claim 2, wherein each of said two bores has
an accommodation zone which has a first larger dimension, and which is in radial alignment with the corresponding one of said two internal ports to ease entry of the viscous liquid, said accommodation zone being disposed to fluidly communicate the corresponding one of said two internal ports with said front zone,
a fitting zone which has a second larger dimension, and which is disposed adjacent to said rearward end of said delivery head, and
a neck zone of a smaller dimension, which is disposed between said accommodation zone and said fitting zone, and which defines, together with said fitting zone, an abutment shoulder,
said device further comprising two bushings each having a front end and a rear end, and each being fitted in said fitting zone of the corresponding one of said two bores such that said front end abuts against said abutment shoulder of the corresponding one of said two bores.

9. The device according to claim 8, further comprising
two flange members each being mounted on a corresponding one of said plungers adjacent to said follower end, and
two biasing members each being disposed between said rear end of a corresponding one of said bushings and a corresponding one of said two flange members to bias said plunger end segment of the corresponding one of said two plungers toward the rearward position.

10. A device for delivering a viscous liquid to flow from a reservoir of the viscous liquid to a hose, said device comprising:
a delivery head extending in a longitudinal direction to terminate at a forward end and a rearward end, said delivery head having
an intake port disposed for receiving the viscous liquid from the reservoir,
two bores each extending in the longitudinal direction to terminate at a front valve hole and a rear through hole at said rearward end, each of said two bores having a front zone adjacent to said front valve hole,
two internal ports each being disposed downstream of said intake port and upstream of said front zone of a corresponding one of said two bores,
an outlet port disposed downstream of said front valve holes of said two bores for delivering the viscous liquid into the hose, and
two valve seats each defining said front valve hole of the corresponding one of said two bores;
two check balls each being disposed to couple with a corresponding one of said valve seats to permit a unidirectional flow of the viscous liquid from said front zone of the corresponding one of said two bores to said outlet port through said front valve hole of the corresponding one of said valve seats;
a rear shell body disposed rearwardly of said delivery head, and defining therein a chamber which extends forwardly to terminate at an open end in spatial communication with said rear through holes of said two bores;
a drive source disposed in said chamber, and having an output shaft configured to be driven to rotate about a shaft axis in the longitudinal direction;
two plungers each extending in the longitudinal direction to terminate at a plunger end segment and a follower end, said follower end being located in said chamber, said plunger end segment being slidably disposed in the corresponding one of said two bores, and being displaceable between a forward position, where a corresponding one of said two internal ports is prevented from fluid communication with said front zone of the corresponding one of said two bores, and a rearward position, where the corresponding one of said two internal ports is in fluid communication with said front zone of the corresponding one of said two bores to permit the viscous liquid to be introduced into said front zone of the corresponding one of said two bores through the corresponding one of said two internal ports;
a cam member disposed in said chamber, and configured to be splinedly engaged with said output shaft so as to permit said cam member to rotate with said output shaft, said cam member having a front end which defines a cam path extending in a circumferential direction about the shaft axis, said cam path being configured to permit said follower ends of said two plungers to engage said cam path to provide a camming action such that when said cam member is driven by said output shaft to rotate, by virtue of the camming action, said plunger end segments of said two plungers are alternately displaced from the rearward position to the forward position so as to alternately force the introduced viscous liquid to flow through said front valve hole of the corresponding one of said valve seats to thereby establish a continuous flow of the viscous liquid out of said outlet port; and two biasing members each being disposed to bias said plunger end segments of a corresponding one of said two plungers toward the rearward position.

11. The device according to claim 10, wherein said cam path has
a foremost area configured to permit said plunger end segment of each of said two plungers to reach the forward position, and
a rearmost area configured to permit said plunger end segment of each of said two plungers to reach the rearward position, said foremost and rearmost areas being disposed opposite to each other relative to the shaft axis so as to permit said plunger end segments of said two plungers to be alternately displaced from the rearward position to the forward position.

12. The device according to claim 11, wherein said cam path further has
a front transition zone having said foremost area,
a rear transition zone having said rearmost area,
a ramp-up zone extending from said rear transition zone in a counterclockwise direction to said front transition zone, and
a ramp-down zone extending from said front transition zone in the counterclockwise direction to said rear transition zone.

13. The device according to claim 10, wherein said two plungers are substantially coplanar with said output shaft.

14. The device according to claim 10, wherein each of said two bores further has
an accommodation zone which has a first larger dimension, and which is in radial alignment with the corresponding one of said two internal ports to ease entry of the viscous liquid, said accommodation zone being disposed to fluidly communicate the corresponding one of said two internal ports with said front zone,
a fitting zone which has a second larger dimension, and which is disposed adjacent to said rearward end of said delivery head, and
a neck zone of a smaller dimension, which is disposed between said accommodation zone and said fitting zone, and which defines, together with said fitting zone, an abutment shoulder,
said device further comprising two bushings each having a front end and a rear end, and each being fitted in said fitting zone of the corresponding one of said two bores such that said front end abuts against said abutment shoulder of the corresponding one of said two bores.

15. The device according to claim 14, further comprising two flange members each being mounted on the corresponding one of said plungers adjacent to said follower end, each of said two biasing members being disposed between said rear end of a corresponding one of said two bushings and a corresponding one of said two flange members.
